(19) United States
(12) Patent Application Publication
(10) Pub. No.: US 2012/0076372 A1
(43) Pub. Date: Mar. 29, 2012

(54) MEDICAL IMAGE PROCESSING APPARATUS AND MEDICAL IMAGE PROCESSING METHOD

(75) Inventors: Hirokazu NISHIMURA, Tokyo (JP); Kenichi TANAKA, Tokyo (JP); Yusuke TOMOTO, Tokyo (JP)

(73) Assignee: OLYMPUS MEDICAL SYSTEMS CORP., Tokyo (JP)

(21) Appl. No.: 13/197,458

(22) Filed: Aug. 3, 2011

Related U.S. Application Data
(63) Continuation of application No. PCT/JP2011/056425, filed on Mar. 17, 2011.

(30) Foreign Application Priority Data
Apr. 12, 2010 (JP) 2010091671

(51) Int. Cl. G06K 9/00

(52) U.S. Cl. 382/128

(57) ABSTRACT

A medical image processing apparatus is a medical image processing apparatus performing image segmentation processing for a medical image including: a feature value calculating unit that calculates at least one feature value from the medical image; a category setting unit that sets, on the basis of the feature value calculated by the feature value calculating unit, plural categories in the medical image; a parameter setting unit that sets, on the basis of the feature value calculated by the feature value calculating unit, a parameter for each of areas of the medical image respectively classified into the categories set by the category setting unit; and an image segmenting unit that performs the image segmentation processing for the medical image according to an arithmetic operation of employing a dynamic contour model specified according to the number of categories set by the category setting unit and parameters set by the parameter setting unit.

### CROSS REFERENCE TO RELATED APPLICATION

This application is a continuation application of PCT/JP2011/056425 filed on Mar. 17, 2011 and claims benefit of Japanese Application No. 2010-091671 filed in Japan on Apr. 12, 2010, the entire contents of which are incorporated herein by this reference.

### BACKGROUND OF THE INVENTION

1. Field of the Invention

The present invention relates to a medical image processing apparatus and a medical image processing method, and, more particularly to a medical image processing apparatus and a medical image processing method for applying image segmentation processing to a medical image obtained by picking up an image of a living tissue.

2. Description of the Related Art

A technique for detecting, on the basis of a calculation result of a feature value of an image obtained by picking up an image of a living tissue, an area where a predetermined object is present in the image has been conventionally used. A method of subjecting an image to image segmentation by a dynamic contour detecting method that can perform a phase change such as a Level-Set method is disclosed in Yasushi Yagi and Hideo Saito eds.: “Computer Vision Forefront Guide <1>”, pp. 1-28, Advanced Communication Media Co., Ltd. (2009), Tony F. Chan and Luminita A. Vese: “Active Contours Without Edges”, IEEE TRANSACTIONS ON IMAGE PROCESSING, VOL. 10, NO. 2, February 2001, pp. 266-277, and Christophe Samson, Laure Blanc-Feraud, Gilles Aubert, and Josiane Zerubia: “Multiphase Evolution and Variational Image Classification”, INRIA Sophia Antipolis (1999) (hereinafter referred to as Non-Patent Documents).

Further, for example, Japanese Patent Application Laid-Open Publication No. 2007-313119 discloses a technique for calculating edge intensity of a pixel in an intra-body cavity image, calculating a correlation value between the edge intensity and a bubble model set in advance on the basis of a characteristic of a bubble image, subjecting the intra-body cavity image to image segmentation on the basis of an edge of the intra-body cavity image, and detecting a bubble area in the intra-body cavity image on the basis of the correlation value and a result of the image segmentation.

### SUMMARY OF THE INVENTION

A medical image processing apparatus according to an aspect of the present invention is a medical image processing apparatus capable of performing image segmentation processing for a medical image including: a feature value calculating unit that calculates at least one feature value from the medical image; a category setting unit that sets, on the basis of the feature value calculated by the feature value calculating unit, plural categories in the medical image; a parameter setting unit that sets, on the basis of the feature value calculated by the feature value calculating unit, a parameter for each of areas of the medical image respectively classified into the categories set by the category setting unit; and an image segmenting unit that performs the image segmentation processing for the medical image according to an arithmetic operation of a contour detecting method employing a dynamic contour model specified according to the number of categories set by the category setting unit and parameters set by the parameter setting unit.

A medical image processing apparatus according to another aspect of the present invention is a medical image processing apparatus capable of performing image segmentation processing for a medical image including: a feature value calculating unit that calculates at least one feature value from the medical image; a structural component area setting unit that sets plural structural component areas corresponding to structural components included in the medical image; an area integrating unit that integrates areas having the feature value similar to each other in the respective plural structural component areas; a category setting unit that sets categories on the basis of a result of the integration by the area integrating unit; a parameter setting unit that sets, on the basis of the feature value in the respective structural component areas obtained as the result of the integration by the area integrating unit, a parameter for each of the structural component areas obtained as the integration result; and an image segmenting unit that performs the image segmentation processing for the medical image according to an arithmetic operation of a contour detecting method employing a dynamic contour model specified according to the number of categories set by the category setting unit and parameters set by the parameter setting unit.

A medical image processing method according to still another aspect of the present invention is a medical image processing method for performing image segmentation processing for a medical image including: a feature value calculating step for calculating at least one feature value from the medical image; a category setting step for setting, on the basis of the feature value calculated by the feature value calculating step, plural categories in the medical image; a parameter setting step for setting, on the basis of the feature value calculated by the feature value calculating step, a parameter for each of areas of the medical image respectively classified into the categories set by the category setting step; and an image segmenting step for performing the image segmentation processing for the medical image according to an arithmetic operation of a contour detecting method employing a dynamic contour model specified according to the number of categories set by the category setting step and parameters set by the parameter setting step.

A medical image processing method according to still another aspect of the present invention is a medical image processing method for performing image segmentation processing for a medical image including: a feature value calculating step for calculating at least one feature value from the medical image; a structural component area setting step for setting plural structural component areas corresponding to structural components included in the medical image; an area integrating step for integrating areas having the feature value similar to each other in the respective plural structural component areas; a category setting step for setting categories on the basis of a result of the integration by the area integrating step; a parameter setting step for setting, on the basis of the feature value in the respective structural component areas obtained as the result of the integration by the area integrating step, a parameter for each of the structural component areas obtained as the integration result; and an image segmenting step for performing the image segmentation processing for the medical image according to an arithmetic operation of a contour detecting method employing a dynamic contour model specified according to the number of categories set by the category setting step and parameters set by the parameter setting step.

### BRIEF DESCRIPTION OF THE DRAWINGS

FIG. 1 is a diagram showing an example of a configuration of a main part of an endoscope apparatus including a medical image processing apparatus according to an embodiment of the present invention;

FIG. 2 is a diagram showing an example of a configuration of a rotating filter included in a light source device shown in FIG. 1;

FIG. 3 is a diagram showing an example of a transmission characteristic of filters included in a first filter groups shown in FIG. 2;

FIG. 4 is a diagram showing an example of a transmission characteristic of filters included in a second filter group shown in FIG. 2;

FIG. 5 is a flowchart showing an example of processing performed in a first embodiment of the present invention;

FIG. 6 is a schematic diagram showing an example of image data set as a processing target;

FIG. 7 is a diagram showing an example of an edge detection filter;

FIG. 8 is a diagram showing a case in which plural circles are set as an initial solution of an arithmetic operation related to image segmentation in the image data shown in FIG. 6;

FIG. 9 is a diagram showing an example of an arithmetic operation in progress related to image segmentation processing;

FIG. 10 is a diagram showing an example of a processing result obtained by the arithmetic operation related to the image segmentation processing;

FIG. 11 is a flowchart showing an example of processing performed in a second embodiment of the present invention;

FIG. 12 is a diagram showing an example of a mixed normal distribution related to an occurrence frequency of a predetermined color-tone feature value in each pixel of image data; and

FIG. 13 is a diagram showing an example of two normal distributions estimated on the basis of the mixed normal distribution shown in FIG. 12.

### DETAILED DESCRIPTION OF THE PREFERRED EMBODIMENTS

Embodiments of the present invention are explained below with reference to the drawings.

### First Embodiment

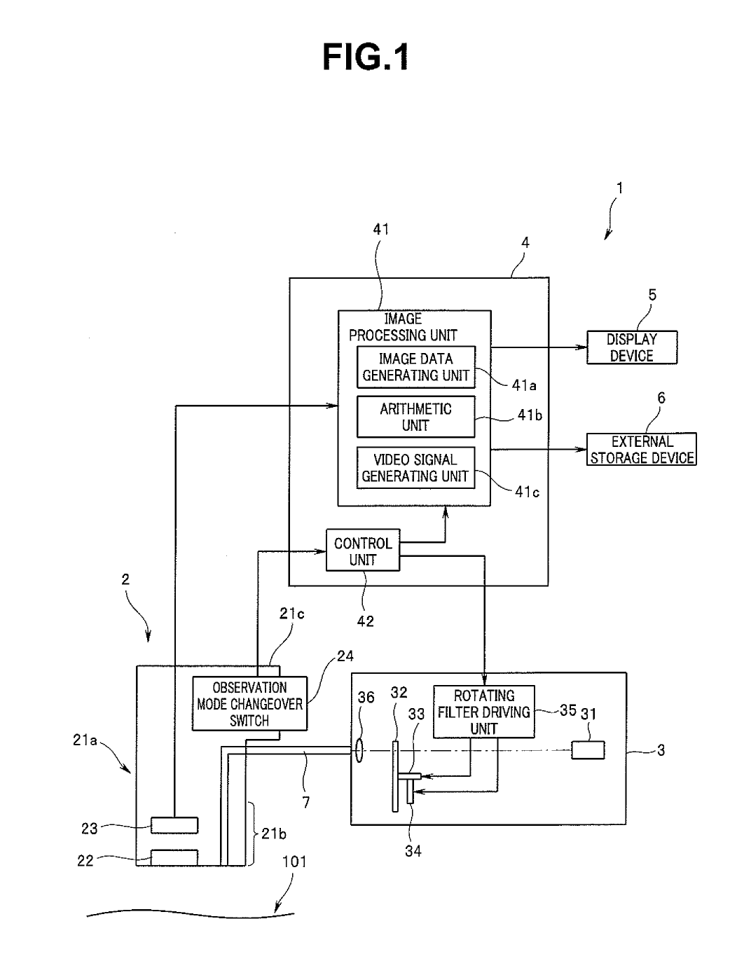

FIGS. 1 to 10 relate to a first embodiment of the present invention.

An endoscope apparatus 1 includes, as shown in FIG. 1, an endoscope 2 that is inserted into a body cavity of an examinee and outputs, as a signal, an image obtained by picking up an image of a subject such as a living tissue 101 in the body cavity; a light source device 3 that emits illumination light for illuminating the living tissue 101, a processor 4 that applies various kinds of processing to the output signal from the endoscope 2, a display device 5 that displays an image corresponding to a video signal from the processor 4, and an external storage device 6 that stores an output signal corresponding to a processing result in the processor 4.

The endoscope 2 includes an insertion portion 21a having a shape and a dimension for allowing insertion into the body cavity of the examinee, a distal end portion 21b provided on a distal end side of the insertion portion 21a, and an operation portion 21c provided on a proximal end side of the insertion portion 21a. A light guide 7 for transmitting the illumination light emitted in the light source device 3 to the distal end portion 21b is inserted through an inside of the insertion portion 21a.

One end face (a light incident end face) of the light guide 7 is detachably connected to the light source device 3. The other end face (a light exit end face) of the light guide 7 is arranged near a not-shown illumination optical system provided at the distal end portion 21b of the endoscope 2. With such a configuration, the illumination light emitted in the light source device 3 is emitted to the living tissue 101 after passing through the light guide 7 connected to the light source device 3 and the not-shown illumination optical system provided at the distal end portion 21b.

An object optical system 22 that forms an optical image of a subject and a CCD 23 that picks up the optical image formed by the object optical system 22 and acquires an image are provided at the distal end portion 21b of the endoscope 2. An observation mode changeover switch 24 that can perform an instruction for switching an observation mode to a normal light observation mode or a narrowband light observation mode is provided in the operation portion 21c of the endoscope 2.

The light source device 3 includes a white light source 31 including a Xenon lamp, a rotating filter 32 that changes white light emitted from the white light source 31 to frame-sequential illumination light, a motor 33 that drives to rotate the rotating filter 32, a motor 34 that moves the rotating filter 32 and the motor 33 in a direction perpendicular to an emission optical path of the white light source 31, a rotating filter driving unit 35 that drives the motors 33 and 34 on the basis of control by the processor 4, and a condensing optical system 36 that condenses illumination light passed through the rotating filter 32 and supplies the illumination light to the incident end face of the light guide 7.

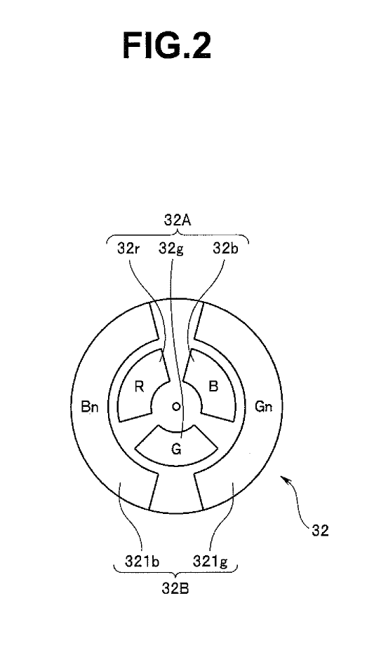

As shown in FIG. 2, the rotating filter 32 is configured in a disk shape having a rotating shaft in a center and includes a first filter group 32A including plural filters provided along a circumferential direction on an inner circumferential side and a second filter group 32B including plural filters provided along a circumferential direction on an outer circumferential side. Driving force of the motor 33 is transmitted to the rotating shaft, whereby the rotating filter 32 rotates. In the rotating filter 32, portions other than portions where the filters of the first filter group 32A and the second filter group 32B are arranged are made of a light blocking member.

The first filter group 32A includes an R filter 32r that transmits light in a wavelength band of red, a G filter 32g that transmits light in a wavelength band of green, and a B filter 32b that transmits light in a wavelength band of blue. The filters 32r, 32g, and 32b are provided along the circumferential direction on the inner circumferential side of the rotating filter 32.

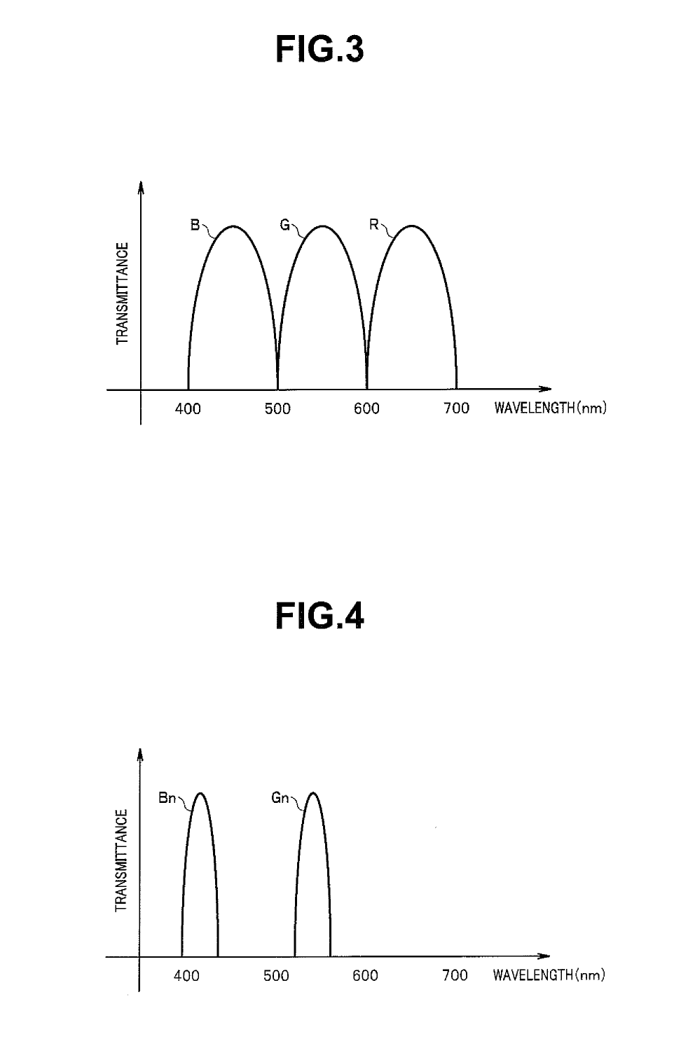

For example, as shown in FIG. 3, the R filter 32r has a configuration for mainly transmitting light of 600 nm to 700 nm (R light). For example, as shown in FIG. 3, the G filter 32g has a configuration for mainly transmitting light of 500 nm to 600 nm (G light). For example, as shown in FIG. 3, the B filter 32b has a configuration for mainly transmitting light of 400 nm to 500 nm (B light).

In other words, the white light emitted in the white light source 31 passes through the first filter group 32A, whereby wideband light for the normal light observation mode is generated.

The second filter group 32B includes a Bn filter 321b that transmits blue and narrowband light and a Gn filter 321g that transmits green and narrowband light. The filters 321b and 321g are provided along the circumferential direction on the outer circumferential side of the rotating filter 32.

For example, as shown in FIG. 4, the Bn filter 321b has a center wavelength set near 415 nm and is configured to transmit light in a narrow band compared with B light (Bn light).

For example, as shown in FIG. 4, the Gn filter 321g has a center wavelength set near 540 nm and is configured to transmit light in a narrow band compared with G light (Gn light).

In other words, the white light emitted in the white light source 31 is dispersed through the second filter group 32B, whereby narrowband light in plural bands for the narrowband light observation mode is generated.

The processor 4 includes a function of an image processing apparatus. Specifically, the processor 4 includes an image processing unit 41 and a control unit 42. The image processing unit 41 includes an image data generating unit 41a, an arithmetic unit 41b, and a video signal generating unit 41c.

The image data generating unit 41a of the image processing unit 41 applies processing such as noise removal and A/D conversion to an output signal from the endoscope 2 on the basis of control by the control unit 42 to thereby generate image data corresponding to an image obtained in the CCD 23.

The arithmetic unit 41b of the image processing unit 41 performs predetermined processing using the image data generated by the image data generating unit 41a to thereby perform image segmentation processing for image data obtained by picking up an image of the living tissue 101. In the present embodiment, it is assumed that a blood vessel is included in the image data and image segmentation processing for distinguishing an area where the blood vessel is present from other areas in the image data is performed. Details of such image segmentation processing are explained later in detail.

The video signal generating unit 41c of the image processing unit 41 applies processing such as gamma conversion and D/A conversion to the image data generated by the image data generating unit 41a to thereby generate and output a video signal.

When it is detected that an instruction for switching the observation mode to the normal light observation mode is performed on the basis of an instruction of the observation mode changeover switch 24, the control unit 42 applies control for causing the light source device 3 to emit wideband light for the normal light observation mode to the rotating filter driving unit 35. The rotating filter driving unit 35 causes, on the basis of control by the control unit 42, the motor 34 to operate to interpose the first filter group 32A on the emission optical path of the white light source 31 and retract the second filter group 32B from the emission optical path of the white light source 31.

When it is detected that an instruction for switching the observation mode to the narrowband light observation mode is performed on the basis of an instruction of the observation mode changeover switch 24, the control unit 42 applies control for causing the light source device 3 to emit narrowband light in plural bands for the narrowband light observation mode to the rotating filter driving unit 35. The rotating filter driving unit 35 causes, on the basis of control by the control unit 42, the motor 34 to operate to interpose the second filter group 32B on the emission optical path of the white light source 31 and retract the first filter group 32A from the emission optical path of the white light source 31.

In other words, with the configuration of the endoscope apparatus 1 explained above, when the normal light observation mode is selected, it is possible to cause the display device 5 to display an image having a color tone substantially the same as a color tone of an object seen by naked eyes (a normal light image) and (or) cause the external storage device 6 to store the image. With the configuration of the endoscope apparatus 1 explained above, when the narrowband light observation mode is selected, it is possible to cause the display device 5 to display an image with a blood vessel included in the living tissue 101 highlighted (a narrowband light image) and (or) cause the external storage device 6 to store the image.

Actions of the present embodiment are explained below.

After turning on a power supply for the units of the endoscope apparatus 1, a surgeon selects the normal light observation mode in the observation mode changeover switch 24. The surgeon inserts the endoscope 2 into a body cavity while looking at an image displayed on the display device 5 when the normal light observation mode is selected, i.e., an image having a color tone substantially the same as a color tone of an object seen by naked eyes to thereby bring the distal end portion 21b close to an area where the living tissue 101 as an observation target is present.

When the normal light observation mode is selected in the observation mode changeover switch 24, lights of respective colors, i.e., R light, G light, and B light are sequentially emitted from the light source device 3 to the living tissue 101. Images respectively corresponding to the lights of the respective colors are acquired in the endoscope 2.

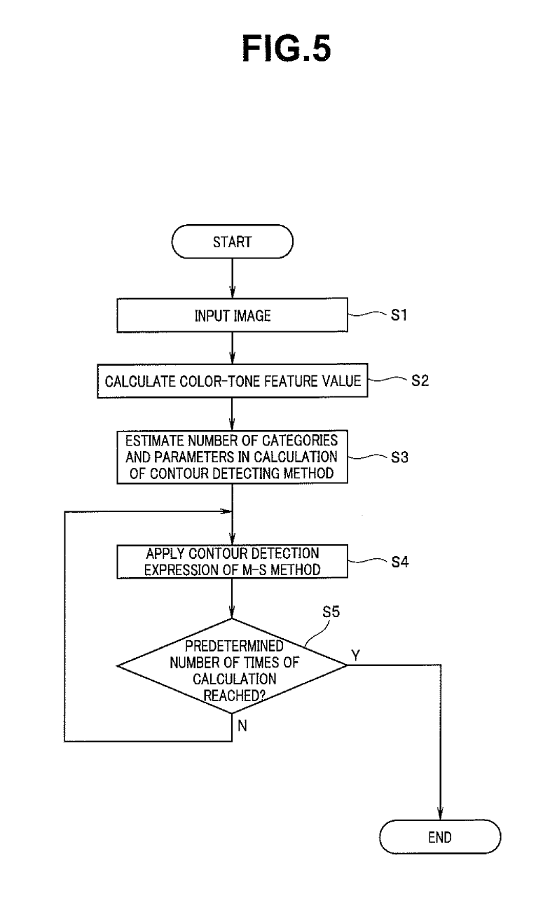

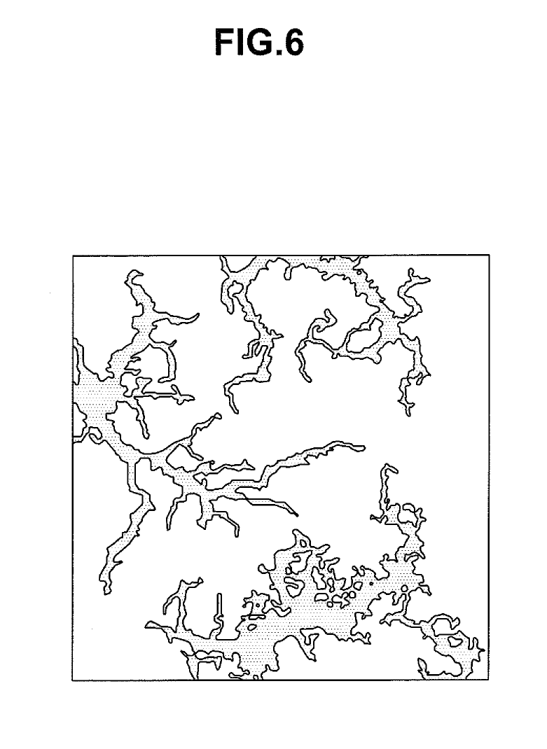

When the image corresponding to the R light, the image corresponding to the G light, and the image corresponding to the B light are inputted, the image data generating unit 41a of the image processing unit 41 generates image data respectively corresponding to the images (step S1 in FIG. 5).

In the present embodiment, it is assumed that image data that is formed by three planes for R, G, and B and includes an image size of a horizontal direction ISX and a vertical direction ISY and gradations of each of the pixels are 8 bits of 0 to 255 is generated by the image data generating unit 41a. In the following explanation, pixel values of jth (1≦j≦ISX×ISY) pixels in the planes for R, G, and B are respectively represented as rj, gj, and bj.

The arithmetic unit 41b of the image processing unit 41 calculates, on the basis of the image data generated by the image data generating unit 41a, for each of the pixels of the image data, a predetermined color-tone feature value used for the following processing (step S2 in FIG. 5).

More specifically, the arithmetic unit 41b in the present embodiment calculates, for each of the pixels (in all first to (ISX×ISY) pixels), a value of gj/rj, which is a ratio of a pixel value rj of a jth pixel of the R plane and a pixel value gj of a jth pixel of the G plane, as the predetermined color-tone feature value (a color-tone feature value calculated on the basis of image data generated when the normal light observation mode is selected).

In the present embodiment, the following explanation is made assuming that the pixel value rj≠0 always holds and assuming that an occurrence frequency of the predetermined color-tone feature value conforms to a normal distribution (a multivariate normal distribution).

Thereafter, the arithmetic unit 41b of the image processing unit 41 performs, using the predetermined color-tone feature value calculated in step S2 in FIG. 5, image segmentation processing for distinguishing an area where a blood vessel is present in the living tissue 101 from other areas.

Details of the image segmentation processing in the present embodiment are explained. In the following explanation, for simplification of the explanation, it is assumed that processing is applied to schematic image data in which an area equivalent to an inside of a blood vessel (an inner side of the blood vessel) is represented as a dot pattern, an area equivalent to a background mucous membrane (an outer side of the blood vessel) is represented as white, and a boundary line of these two areas are represented as a thin solid line, for example, as shown in FIG. 6.

FIG. 6 schematically shows a blood vessel exhibiting a complicated shape called an aggregated veinlet of a tunica mucosa ventriculi observed using a magnification endoscope. According to an actual endoscopic image, not only image data including only a blood vessel and a background mucous membrane area but also image data further including various structures such as a micro vessel and a fundic pit (pit opening) that branch from the aggregated veinlet and run toward a surface layer mucous membrane is acquired. It is possible to apply a series of processing explained below by increasing the number of categories as appropriate regarding that these various structures belong to other categories different from both the blood vessel and the background mucous membrane area.

The arithmetic unit 41b performs an arithmetic operation for estimating the number of categories and a parameter for each of the categories in an arithmetic operation of a contour detecting method employing a dynamic contour model similar to a Mumford-Shah model disclosed in the Non-Patent Document (Christophe Samson, Laure Blanc-Feraud, Gilles Aubert, and Josiane Zerubia: “Multiphase Evolution and Variational Image Classification”, INRIA Sophia Antipolis) (step S3 in FIG. 5). An example of such a method of estimating a parameter is explained below.

First, processing for extracting an area having clear various structural components and a background area such as an interstitial portion from an image and calculating the number of categories and a parameter for each of the categories based on feature values of these areas is explained.

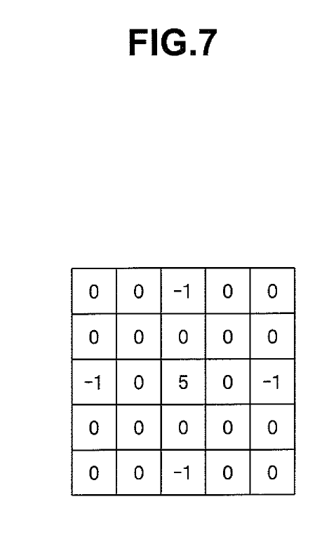

The arithmetic unit 41b extracts, by applying a convolutional operation employing a publicly-known edge detection filter (e.g., a filter having a size 5×5 shown in FIG. 7) to the G plane of the schematic image data shown in FIG. 6, an area having a large edge (an area having large fluctuation in a pixel value and a long edge) and a global background area (an area rarely having an edge). Specifically, when an image after application of edge detection filtering is represented as Ga and a pixel value of a jth (1≦j≦ISX×ISY) pixel in the image Ga is represented as gaj, for example, after binarizing and extracting each pixel in a range of |ga|>0 (| | represents an absolute value), the arithmetic unit 41b creates an edge map M by applying publicly-known labeling to each of linked components. The following explanation is continued assuming that, in the edge map M created in this way, labeled C (1C) linked components are present and representing the linked components as mc (1≦c≦C).

In the image Ga obtained on the basis of a micro structure of a mucous membrane surface in a normal endoscopic image when a stain or the like is not used, since hemoglobin absorbs a wavelength component included in the G light, a pixel value of a blood vessel is relatively small with respect to a pixel value of a peripheral mucous membrane. In the image Ga, since the wavelength component included in the G light is reflected, a pixel value of a pit is relatively large with respect to the pixel value of the peripheral mucous membrane. It is possible to extract various categories by making use of such a characteristic.

On the other hand, the arithmetic unit 41b creates a large edge map L different from the edge map M in order to extract a clear edge of a blood vessel. Specifically, the arithmetic unit 41b creates the large edge map L by binarizing and extracting each pixel in a range of |gaj|>Th1 (e.g., Th1=10). The threshold Th1 is not limited to a threshold set as a fixed value and may be, for example, a threshold adaptively determined to include pixel values of higher order 20% in a histogram related to the pixel value gaj.

A reason for creating the large edge map L is as explained below.

According to the schematic image data shown in FIG. 6, only the blood vessel and the background area are present in the image. However, according to an actual endoscopic image, various blood vessels, other structural components, and noise components could be included in the endoscopic image. Therefore, when the edge map M is created, edges of the blood vessels, the structural components, and the noise components are extracted as being in the range of |gaj|>0. In view of such circumstances, the large edge map L different from the edge map M is created, whereby a large edge forming a closed area or a large edge included in at least a part of the closed area is specified. By performing processing explained later, it is possible to exclude a structural component and a noise component formed only by an edge having a small value, i.e., it is possible to specify only a relatively clear structural component.

Subsequently, the arithmetic unit 41b performs, by alternately referring to the edge map M and the large edge map L, processing for selecting (one or plural) linked components mc that overlap a pixel in which it is determined that a large edge is present in the large edge map L among linked components m1 to mC of the edge map M. According to such processing, it is possible to extract only (one or plural) linked components in which it is highly likely that an image of a blood vessel is picked up equivalent to an area having a large edge among the liked components of the edge map M.

Further, the arithmetic unit 41b extracts, on the basis of a processing result of the processing, respective closed areas formed by the linked components mc determined as linked components having a large edge using, for example, a closed area detecting method disclosed in Japanese Patent Application Laid-Open Publication No. 11-003428. Representative areas Ad (1≦d≦D) extracted in this way are extracted as areas including various structural components set as targets of image segmentation in an image and areas including relatively clear structural components among the various structural components.

The arithmetic unit 41b regards, as a global background area, a pixel group not extracted as an edge in the edge map M and extracts the pixel group.

Thereafter, the arithmetic unit 41b repeats processing for integrating areas having values of color-tone feature values gj/rj similar to each other as one category in the extracted each representative area Ad to thereby estimate the number of all categories K (1≦K) included in the schematic image data shown in FIG. 6. As such processing, it is possible to apply processing related to clustering employing a color-tone feature value and a histogram of the color-tone feature value disclosed in, for example, Japanese Patent Application Laid-Open Publication No. 2007-175432.

Subsequently, in the respective K categories obtained by the processing explained above, the arithmetic unit 41b calculates μGRᵢ and σGRᵢ (1≦i≦K), which are an average and a standard deviation of values of the color-tone feature values gj/rj.

Concerning the calculation of the number of categories and a parameter, a processing target area can also be set as an area corresponding to manual operation by the surgeon or the like. In such a case, the arithmetic unit 41b only has to set an area including a structural component such as a blood vessel and a background mucous membrane area on the basis of input operation performed in a not-shown input interface, give category numbers i (1≦i≦K, K is the number of categories) to the set areas, and acquire a calculation result obtained by calculating an average and a standard deviation of the color-tone feature values gj/rj for each of the areas to which the category numbers are given.

In the estimation methods enumerated above, it is possible to improve estimation accuracy for a parameter by, before estimating a parameter, excluding a pixel having a value of a color-tone feature value that could occur redundantly in plural categories.

Concerning a pixel not suitable for calculation of a color-tone feature value such as a pixel not having sufficient brightness and a high-luminance pixel like halation, estimation of a parameter may be performed after the pixel is excluded by threshold processing.

Further, in the series of processing explained above, the processing is not limited to processing for performing estimation of a parameter on the basis of the image Ga in which the edge detection filter is applied to the G plane and may be, for example, processing for performing estimation of a parameter directly using values of the color-tone feature values gj/rj of each pixel. When estimation of a parameter is performed directly using the values of the color-tone feature values gj/rj, it is possible to reduce influences due to a magnitude of a light amount, shading, and the like, which could be a factor of exponential fluctuation of a pixel value. When estimation of a parameter is performed directly using the values of the color-tone feature values gj/rj, a series of thresholds only have to be determined as appropriate taking into account the fact that values of gj/rj in a normal endoscopic image generally fit within a range of 0≦gj/rj≦1.

In mucous membrane micro structures such as a blood vessel and a pit, it often occurs that, because of factors such as what kind of tissue characteristics the mucous membrane micro structures have and in how deep positions under a mucous membrane the mucous membrane micro structures are present, color tones of the mucous membrane micro structures are different from each other regardless of the fact that the mucous membrane micro structures belong to the same category as histologic structures. In such a case, for example, mucous membrane micro structures only have to be separated into plural categories such as a blood vessel 1 and a blood vessel 2 and a parameter only has to be estimated for each of the plural categories. Specifically, this can be realized by, after appropriately setting an integration criterion in performing integration of the representative areas Ad or a separation criterion for areas after the integration of the representative areas Ad is performed and estimating a final number of categories, estimating a parameter for each of the categories.

The series of processing explained above is not limited to processing for using the values of gj/rj as color-tone feature values and may be, for example, processing for appropriately selecting and using one of values of gj/rj or values of bj/gj as color-tone feature values corresponding to a category set as an extraction target.

In other words, according to the estimation methods explained above, it is possible to obtain an estimation result that the K categories in total are included in the schematic image data shown in FIG. 6. Further, according to the estimation methods explained above, it is possible to obtain, as estimation results of parameters, an average μGRᵢ and a standard deviation σGRᵢ of values of the predetermined color-tone feature values gj/rj in an ith category among all the K categories. In the following explanation, for simplification of the explanation, it is assumed that only two categories of an area equivalent to an inside of a blood vessel (an inner side of the blood vessel) and an area equivalent to a background mucous membrane such as an interstitial portion (an outer side of the blood vessel) are included in the schematic image data shown in FIG. 6 (K=2 and i=1 or 2).

On the other hand, the arithmetic unit 41b performs an arithmetic operation related to image segmentation by applying the number of categories and the estimation results of parameters obtained in step S3 in FIG. 5 to a contour detection expression of an M-S method (step S4 in FIG. 5). In the present embodiment, as the contour detection expression, the following Equation (1) disclosed in Non-Patent Document (Christophe Samson, Laure Blanc-Feraud, Gilles Aubert, and Josiane Zerubia: “Multiphase Evolution and Variational Image Classification”, INRIA Sophia Antipolis) is used.

$${F}_{α} ( {Φ}_{1} , … , {Φ}_{K} ) = {\sum }_{i = 1}^{K} {e}_{i} {\int }_{Ω}^{ } {H}_{α} ( {Φ}_{i} ) \frac{{( {u}_{0} - {μ}_{i} )}^{2}}{{σ}_{i}^{2}} d x + {\sum }_{i = 1}^{K} {γ}_{i} {\int }_{Ω}^{ } {δ}_{α} ( {Φ}_{i} ) \vert ∇ {Φ}_{i} \vert d x + \frac{λ}{2} {\int }_{Ω}^{ } {( {\sum }_{i = 1}^{K} {H}_{α} ( {Φ}_{i} ) - 1 )}^{2} d x \qquad ( 1 )$$

Φᵢ (1≦i≦K) in Equation (1) is called distance function. A pixel at Φᵢ=0 is a boundary of an area. Values of Φᵢ in other pixels are set according to distances from the boundary. Specifically, concerning a pixel present on an inside of the boundary (an inner side of the area), a value of Φᵢ takes a positive value corresponding to a distance from the boundary. Concerning a pixel present on an outside of the boundary (an outer side of the area), the value of Φᵢ takes a negative value corresponding to a distance from the boundary.

F_{α}(Φ₁, . . . , Φ_{K}) in Equation (1) indicates an evaluation value obtained when an entire area Ω including all the K categories is subjected to image segmentation. In other words, it is possible to realize image segmentation of an image by calculating, through repeated processing (for example, explained later), a boundary for minimizing a value of F_{α}(Φ₁, . . . , Φ_{K}).

Three terms on a right side in Equation (1) respectively mean in order a term that is smaller as a parameter of a feature value in a segmented area is closer to and σᵢ, a term that is smaller as length of a boundary line is smaller (less complicated), and a term for controlling redundancy of an area and the like.

On the other hand, in image segmentation employing the M-S method, the distance function Φᵢ for minimizing the evaluation value F_{α}(Φ₁, Φ_{K}) can be calculated through repeated processing of the following Equation (2).

$${Φ}_{i}^{t + 1} = {Φ}_{i}^{t} - d t ( {δ}_{α} ( {Φ}_{i} ) [ {e}_{i} \frac{{( {u}_{0} - {μ}_{i} )}^{2}}{{σ}_{i}^{2}} - {γ}_{i} div ( \frac{∇ {Φ}_{i}}{\vert ∇ {Φ}_{i} \vert} ) + λ ( {\sum }_{i = 1}^{K} {H}_{α} ( {Φ}_{i} ) - 1 ) ] ) \qquad ( 2 )$$

In Equation (2), t is a suffix indicating the number of times of repetition (0≦t) in the repeated processing. In Equation (2), t=0 means that a boundary is an initial solution.

In the repeated processing employing Equation (2), the arithmetic unit 41b acquires, as an image segmentation result that converges to a final boundary, a processing result obtained when it is detected that a value of the evaluation value F_{α}(Φ₁, Φ_{K}) calculated using the distance functions Φᵢ respectively obtained when the number of times of repetition reaches t times and (t+1) times is 0 (or a very small change such as 0.01) or when it is detected that the number of times of repetition reaches a predetermined number of times of repetition (t=a predetermined value). In the present embodiment, for a reduction in an arithmetic operation time, the processing result obtained when the number of times of repetition reaches the predetermined number of times of repetition (distance functions Φᵢ and evaluation value F_{α}(Φ₁, Φ_{K}) is acquired as an image segmentation result.

In Equations (1) and (2), λ indicates a predetermined constant (a positive real number). Specifically, in the present embodiment, λ is set as 1.0.

In Equations (1) and (2), eᵢ and γᵢ respectively indicate weighting coefficients of a first term and a second term of a right side of categories. Specifically, in the present embodiment, eᵢ and γᵢ are set as eᵢ=e₂= . . . =e_{K}=1.0 and γᵢ=γ₂= . . . =γ_{K}=1.0. Further, according to the present embodiment, values of these weighting coefficients are appropriately changed, whereby significance for each of the terms of the right side or each of the categories is changed. In other words, it is possible to control a convergence result (an image segmentation result) of an area boundary.

In Equations (1) and (2), δ_{α} and H_{α} indicate functions obtained by respectively approximating a delta function of Dirac and a Heaviside distribution.

On the other hand, in step S4 in FIG. 5, the arithmetic unit 41b updates the distance function Φᵢ by substituting the predetermined color-tone feature values gj/rj (for each pixel) obtained as the processing result in step S2 in FIG. 5 in u₀ of Equation (2) and performs an arithmetic operation. In step S4 in FIG. 5, the arithmetic unit 41b substitutes the number of all categories (=2) and the parameters (the average μGRᵢ and the standard deviation σGRᵢ (variance (σGRᵢ)²)) estimated by the processing in step S3 in FIG. 5 in Equation (2) and performs an arithmetic operation.

Thereafter, the arithmetic unit 41b determines whether the number of times of the arithmetic operation in step S4 in FIG. 5 reaches a predetermined number of times of the arithmetic operation (e.g., 2000 times) (step S5 in FIG. 5). When it is detected that the number of times of the arithmetic operation in step S4 in FIG. 5 does not reach the predetermined number of times of the arithmetic operation, the arithmetic unit 41b returns to step S4 in FIG. 5 and calculates the distance function Φᵢ in the next number of times of repetition.

In step S5 in FIG. 5, the arithmetic unit 41b repeats the processing in step S4 until a determination result that the number of times of the arithmetic operation in step S4 in FIG. 5 reaches the predetermined times of the arithmetic operation is obtained. When a determination result that the number of times of the arithmetic operation in step S4 in FIG. 5 reaches the predetermined number of times of the arithmetic operation is obtained in step S5 in FIG. 5, the arithmetic unit 41b ends a series of processing including an arithmetic operation related to the image segmentation.

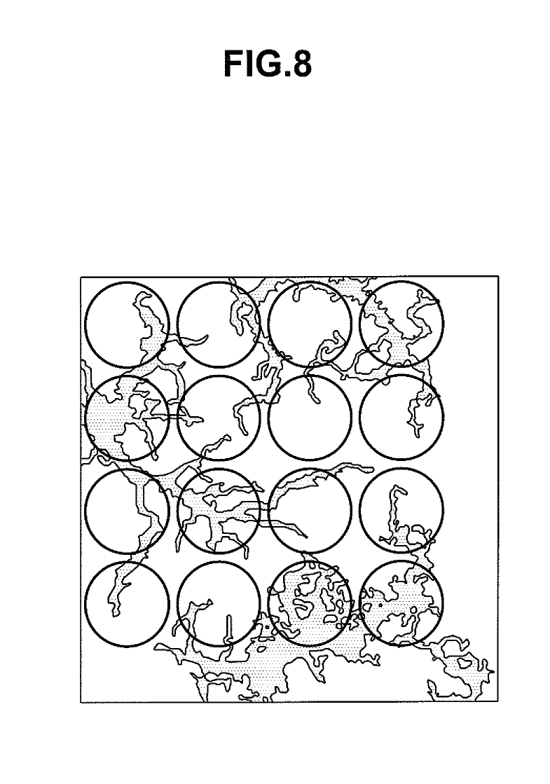

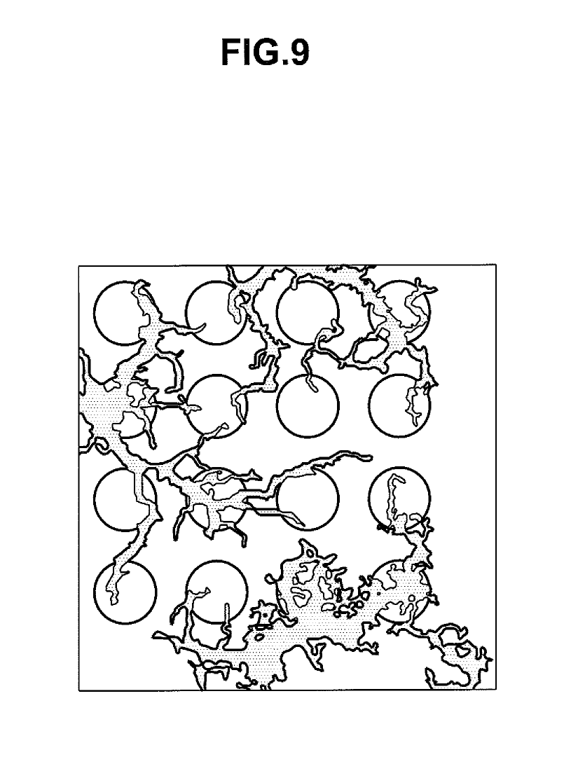

FIG. 8 is a diagram showing a case in which plural circles drawn using thick solid lines are set as an initial solution of an arithmetic operation related to image segmentation in the schematic image data shown in FIG. 6. When such an initial solution is set, for example, an arithmetic operation result shown in FIG. 9 can be obtained when the number of times of the arithmetic operation in step S4 in FIG. 5 reaches 100. When the initial solution is set, when the number of times of the arithmetic operation in step S4 in FIG. 5 reaches the predetermined number of times of the arithmetic operation, it is possible to obtain a (final) image segmentation result in which two areas of an area equivalent to an inside of a blood vessel (an inner side of the blood vessel) and an area equivalent to a background mucous membrane (an outer side of the blood vessel) are completely segmented along a boundary line indicated by a thick solid line.

In other words, according to the present embodiment, since the image segmentation processing explained above is performed using the image data generated by the image data generating unit 41a, it is possible to clearly distinguish an area where a blood vessel is present from other areas in the living tissue 101. As a result, according to the present embodiment, it is possible to improve detection accuracy of a blood vessel present in the living tissue 101 compared with the case in the past.

The image segmentation processing in the present embodiment is not limited to processing performed using an image obtained when the normal light observation mode is selected. The image segmentation processing can be performed in substantially the same manner using, for example, images obtained when the narrowband light observation mode is selected (an image corresponding to Bn light and an image corresponding to Gn light).

The image segmentation processing in the present embodiment is not limited to processing performed using, as the predetermined color-tone feature value, a value obtained by segmenting a pixel value of image data corresponding to the G light by a pixel value of image data corresponding to the R light. The image segmentation processing may be processing performed using, for example, a value obtained by segmenting a pixel value of image data corresponding to the B light by a pixel value of image data corresponding to the G light. The image segmentation processing in the present embodiment may be processing performed using, as the predetermined color-tone feature value, a pixel value of any one of image data corresponding to the R light, the G light, and the B light. Further, the image segmentation processing in the present embodiment may be processing performed using, as the predetermined color-tone feature value, a value after conversion obtained by converting pixel values of an RGB colorimetric system into an HSI colorimetric system or an L*a*b* colorimetric system.

The image segmentation processing in the present embodiment is not limited to processing using, as the predetermined color-tone feature value, only one feature value, an occurrence frequency of which conforms to a normal distribution. Plural feature values, occurrence frequencies of which respectively conform to a multivariate normal distribution, may be simultaneously used. (In this case, a variance-covariance matrix Σ only has to be used as the parameter of Equation (1) instead of a variance σᵢ².)

The image segmentation processing in the present embodiment is not limited to processing for performing image segmentation on the basis of only the two categories, i.e., the area where a blood vessel is present and the area equivalent to the background mucous membrane. The image segmentation processing may be processing for performing image segmentation on the basis of categories equivalent to elements that could be included in an endoscopic image such as a pit of a large intestine, MCE (Marginal Crypt Epithelium), a fur, and mucilage.

In the present embodiment, the image segmentation processing is not limited to processing performed assuming that an occurrence frequency of a color-tone feature value conforms to a normal distribution (a multivariate normal distribution). For example, the image segmentation processing may be performed by appropriately selecting and setting any one of a normal distribution and other probability distributions (other than the normal distribution) according to a distribution state of color-tone feature values in areas set as segmentation targets.

In the present embodiment, the processing for applying clustering to each pixel of an area having a large edge in order to estimate a parameter on the basis of a representative structural component is explained as an example. However, the processing is not limited to this and may be processing for directly performing clustering using feature values of all pixels including a background area.

### Second Embodiment

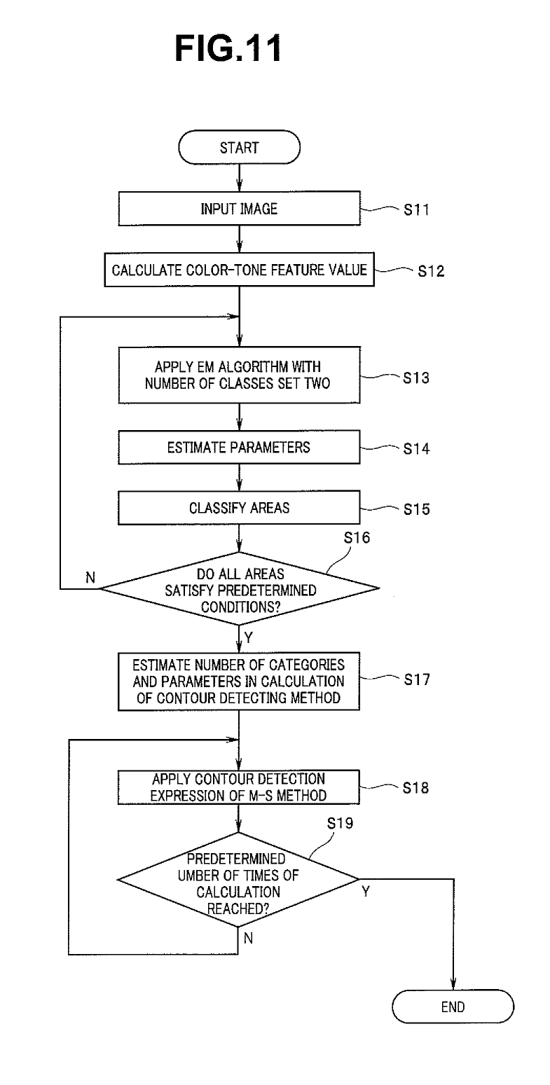

A second embodiment of the present invention is explained next. FIGS. 11 to 13 are diagrams related to the second embodiment of the present invention. In the present embodiment, unlike the first embodiment, a medical image processing apparatus is explained that can satisfactorily estimate the number of categories and parameters of the categories even in an image including a small number of structural components involving a clear edge, i.e., an image in which it is difficult to determine an area representing structural components on the basis of an edge.

In the present embodiment, processing is performed using the endoscope apparatus 1 having a configuration similar to that in the first embodiment. Therefore, in the present embodiment, detailed explanation concerning the configuration of the endoscope apparatus is omitted.

Between the present embodiment and the first embodiment, the number of categories used for an arithmetic operation of Equation (1) and a method of estimating a parameter for each of the categories are mainly different. Therefore, in the present embodiment, differences from the first embodiment are mainly explained and similarities to the first embodiment are explained while omitting the explanation as appropriate.

Actions of the present embodiment are explained below.

First, after turning on a power supply for the units of the endoscope apparatus 1, a surgeon selects the normal light observation mode in the observation mode changeover switch 24. The surgeon inserts the endoscope 2 into a body cavity while looking at an image displayed on the display device 5 when the normal light observation mode is selected, i.e., an image having a color tone substantially the same as a color tone of an object seen by naked eyes to thereby bring the distal end portion 21b close to an area where the living tissue 101 as an observation target is present.

When the normal light observation mode is selected in the observation mode changeover switch 24, lights of respective colors, i.e., R light, G light, and B light are sequentially emitted from the light source device 3 to the living tissue 101. Images respectively corresponding to the lights of the respective colors are acquired in the endoscope 2.

When the image corresponding to the R light, the image corresponding to the G light, and the image corresponding to the B light are inputted, the image data generating unit 41a generates image data corresponding to the images (step S11 in FIG. 11).

The arithmetic unit 41b calculates, on the basis of the image data generated in the image data generating unit 41a, for each of pixels of the image data, values of predetermined color-tone feature values gj/rj used for the following processing (step S12 in FIG. 11).

Thereafter, the arithmetic unit 41b applies an EM algorithm, the number of classes of which is set to 2, in areas that does not satisfy a predetermined condition explained later among all areas present in the schematic image data shown in FIG. 6 (in the case of first processing, an entire area of an image) (step S13 in FIG. 11) to thereby estimate parameters (an average μᵢ and a variance σᵢ² of the predetermined color-tone feature values) in respective two classes (step S14 in FIG. 11).

The EM algorithm is a publicly-known method that can estimate plural parameters in a mixed normal distribution. Therefore, detailed explanation concerning the EM algorithm is omitted.

In the application of the EM algorithm, it is a prerequisite that the number of classes (synonymous with the number of categories) is known. Therefore, in the present embodiment, explanation is made assuming that the EM algorithm is applied to processing for estimating the number of categories present in an image and parameters of the categories by repeating classification in the two classes a sufficient number of times and integrating obtained results.

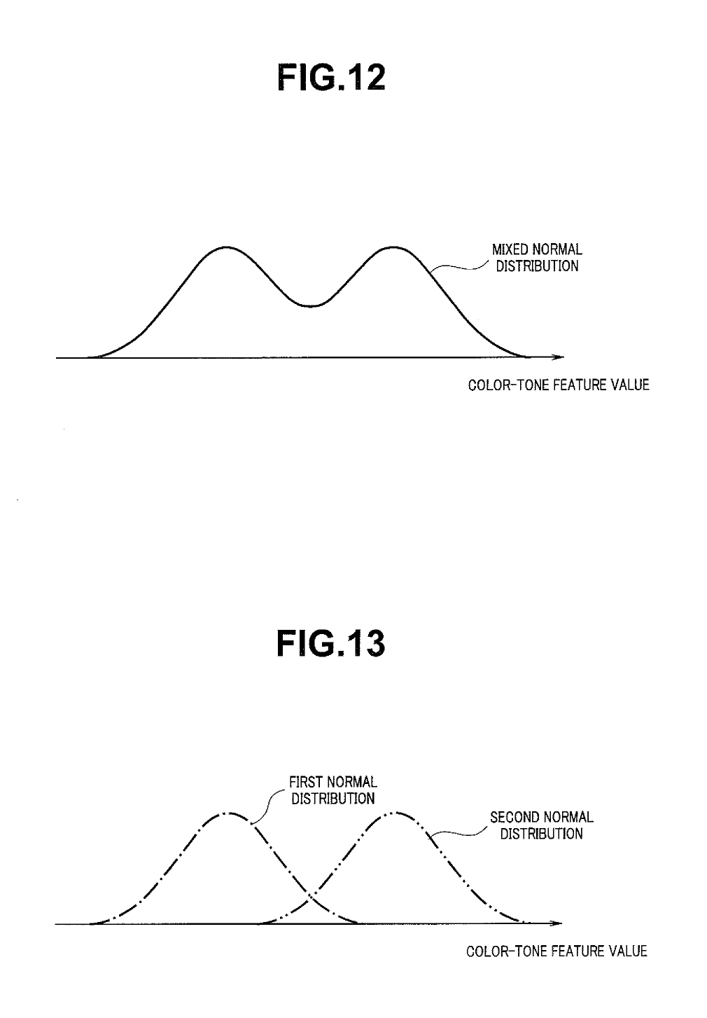

When it is a prerequisite that an occurrence frequency of a predetermined color-tone feature value (e.g., a value obtained by segmenting a pixel value of image data corresponding to the G light by a pixel value of image data corresponding to the R light) in the each pixel of the image data generated by the image data generating unit 41a conforms to a normal distribution, a mixed normal distribution obtained by combining normal distributions of two classes is, for example, as shown in FIG. 12.

The arithmetic unit 41b repeatedly performs arithmetic operations related to an E step and an M step of the EM algorithm until an arithmetic operation stop condition is satisfied (e.g., improvement of likelihood of the two classes is equal to smaller than a threshold; specifically, the threshold only has to be set to 0.01) to thereby respectively estimate parameters (an average and a variance of predetermined color-tone feature values) for specifying a first normal distribution in which a peak of a frequency is a relatively low value and parameters (an average and a variance of predetermined color-tone feature values) for specifying a second normal distribution in which a peak of a frequency is a relatively high value (step S13 and step S14 in FIG. 11). The first normal distribution and the second normal distribution are, for example, as shown in FIG. 13.

Subsequently, the arithmetic unit 41b discriminates, using a normal distribution by the parameters obtained as a result of the arithmetic operation in step S14 in FIG. 11, to which of the first and second normal distributions values of color-tone feature values gj/rj of the each pixel in the schematic image data shown in FIG. 6 are close and gives a label 1 or 2 representing a class (a category) to the each pixel (step S15 in FIG. 11). Specifically, the arithmetic unit 41b determines, using, for example, a publicly-known Euclidian distance or Mahalanobis distance (when a multidimensional feature value is used), to which of average values μp (p=1 or 2) in the first and second normal distributions the values of the color-tone feature values gj/rj of the each pixel are close.

According to the processing explained above, the each pixel in the schematic image data shown in FIG. 6 is classified into the class (the category) 1 or 2 on the basis of the values of the predetermined color-tone feature values gj/rj.

Subsequently, the arithmetic unit 41b determines whether the series of processing in steps S13 to S15 is applied again to the pixel groups classified into the respective classes (the categories) 1 and 2 obtained as a result of the processing in step S15 in FIG. 11 (step S16 in FIG. 11).

According to the first classification processing in step S15 in FIG. 11, the each pixel included in the image is basically classified into the two classes (categories). However, the number of classes (categories) corresponding to structural components actually included in the image or the number of classes (categories) optimum in performing the image segmentation processing is unknown unless separately designated. Therefore, in a classification result obtained by the first classification processing in step S15 in FIG. 11, it is likely that the pixel groups are classified into the two classes (categories) while including pixel groups that should originally be classified into different class (category).

Therefore, in step S16 in FIG. 11, the arithmetic unit 41b according to the present embodiment performs processing for determining, according to whether a predetermined condition is satisfied, whether pixel groups (areas) to which the labels representing the classes (categories) 1 and 2 are given should be further segmented into plural classes (categories). Specifically, for example, when a difference in average values μp between two pixel groups (areas) to which the labels representing the classes (categories) 1 and 2 are given is equal to or smaller than a threshold (e.g., the threshold is set to 0.1), when the number of pixels included in any one of the pixel groups (the areas) obtained as a classification result is equal to or smaller than a threshold (e.g., the threshold is set to 0.1×ISX×ISY), or when the number of times of repetition of the series of processing in steps S13 to S15 reaches a predetermined number of times, the arithmetic unit 41b determines that the predetermined condition is satisfied. When at least one of the pixel groups (the areas) to which the labels representing the classes (the categories) 1 and 2 are given does not satisfy the predetermined condition, the arithmetic unit 41b repeatedly performs processing for applying the series of processing in steps S13 to S15 again to the pixel groups (the areas) that do not satisfy the predetermined condition to thereby further classify the pixel groups (the areas) into two classes (categories).

On the other hand, when all the areas (all the pixel groups) obtained as the result of the processing in step S15 in FIG. 11 satisfy the predetermined condition, the arithmetic unit 41b estimates the number of all categories used for the arithmetic operation of Equation (1) by integrating areas where distribution states of predetermined color-tone feature values (gj/rj) partially overlap each other among all the areas or excluding the areas where the distribution states of the predetermined color-tone feature values (gj/rj) partially overlap each other (step S17 in FIG. 11). The arithmetic unit 41b estimates, as parameters used for the arithmetic operation of Equation (1), a calculation result obtained by calculating an average and a variance of the predetermined color-tone feature values (gj/rj) for each of the categories (step S17 in FIG. 11).

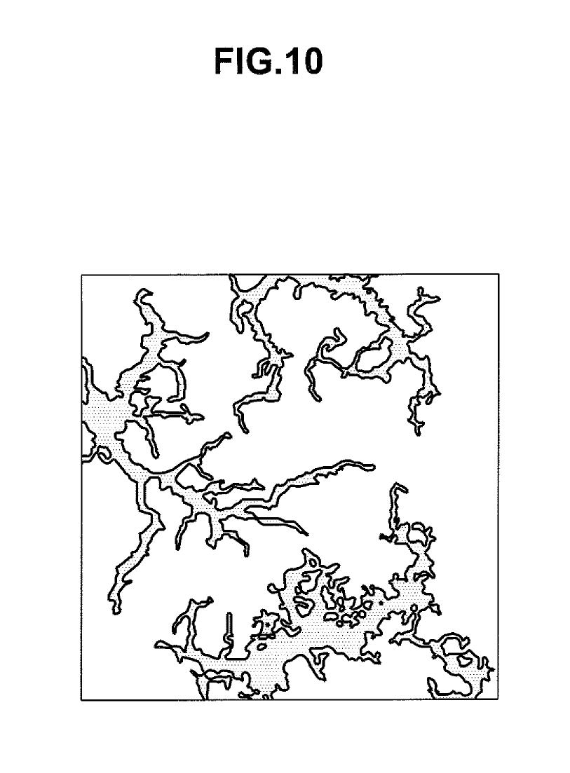

It is assumed that, according to the processing in step S17 in FIG. 11, an estimation result that only two categories of an area equivalent to an inside of a blood vessel (an inner side of the blood vessel) and an area equivalent to a background mucous membrane such as an interstitial portion (an outer side of the blood vessel) are included in the schematic image data shown in FIG. 6. When such an estimation result is obtained, the arithmetic unit 41b can obtain, by performing the same processing as the processing in steps S4 and S5 in FIG. 5 explained in the first embodiment as processing in steps S18 and S19 in FIG. 11, a (final) image segmentation result in which two areas of the area equivalent to the inside of the blood vessel (the inner side of the blood vessel) and the area equivalent to the background mucous membrane (the outer side of the blood vessel) are completely segmented along a boundary line indicated by a thick solid line, for example, as shown in FIG. 10.

In other words, according to the present embodiment, since the image segmentation processing explained above is performed using the image data generated by the image data generating unit 41a, it is possible to clearly distinguish an area where a blood vessel is present from other areas in the living tissue 101. As a result, according to the present embodiment, it is possible to improve detection accuracy of a blood vessel present in the living tissue 101 compared with the case in the past.

After the series of processing in steps S13 to S15 in FIG. 11 is repeatedly performed, when it is determined in step S16 in FIG. 11 that the predetermined condition is satisfied, it is likely to obtain a processing result in which a pixel group that should originally be classified into the same category is excessively segmented. In such a case, areas having close values of parameters may be integrated with each other again by, for example, applying the processing related to clustering disclosed in Japanese Patent Application Laid-Open Publication No. 2007-175432 to the processing result before the processing in step S17 in FIG. 11 is performed.

In the embodiments explained above, the arithmetic operation is performed using the estimation results of the average and the variance of the predetermined color-tone feature values as the parameters of Equation (1). However, it is also possible to perform the image segmentation processing according to a method other than this method. Specifically, for example, according to the contour detecting method disclosed in “Active Contours Without Edges” of IEEE TRANSACTIONS ON IMAGE PROCESSING, VOL. 10, NO. 2 (February 2001), it is possible to obtain an image segmentation processing result substantially the same as those in the embodiments explained above by performing the arithmetic operation using only the estimation result of the average of the predetermined color-tone feature values as a parameter.

The series of processing explained in the embodiments is not limited to processing applied to an endoscopic image and may be, for example, processing applied to an image obtained by a capsule endoscope or processing applied to various medical images such as monochrome images.

In the embodiments explained above, the processing for using color-tone feature values as feature values is explained as an example. However, processing may be performed by appropriately selecting feature values other than the color-tone feature values according to structural components set as segmentation targets or appropriately combining and using the color-tone feature values and the other feature values. Specifically, as the other feature values, for example, structural feature values such as a Gabor features obtained by applying a publicly-known Gabor filter to an image may be used.

In the embodiments explained above, the processing may be performed using color-tone feature values calculated for each pixel or may be performed using color-tone feature values calculated for each small area including plural pixels (e.g., 4×4 pixels).

The present invention is not limited to the embodiments explained above. It goes without saying that various modifications and applications are possible without departing from the spirit of the invention.

What is claimed is:

1. A medical image processing apparatus capable of performing image segmentation processing for a medical image comprising:
a feature value calculating unit that calculates at least one feature value from the medical image;
a category setting unit that sets, on the basis of the feature value calculated by the feature value calculating unit, plural categories in the medical image;
a parameter setting unit that sets, on the basis of the feature value calculated by the feature value calculating unit, a parameter for each of areas of the medical image respectively classified into the categories set by the category setting unit; and
an image segmenting unit that performs the image segmentation processing for the medical image according to an arithmetic operation of a contour detecting method employing a dynamic contour model specified according to a number of categories set by the category setting unit and parameters set by the parameter setting unit.

2. The medical image processing apparatus according to claim 1, further comprising a structural component area extracting unit that extracts an area corresponding to a structural component included in the medical image, wherein
the feature value calculating unit calculates at least one feature value from each of the areas extracted by the structural component area extracting unit, and
the category setting unit sets, on the basis of the feature value calculated by the feature value calculating unit, plural categories corresponding to each of the areas extracted by the structural component area extracting unit.

3. The medical image processing apparatus according to claim 1, wherein
the category setting unit applies clustering processing to the plural categories on the basis of a distribution state of the feature value calculated by the feature value calculating unit,
the parameter setting unit sets, on the basis of the feature value calculated by the feature value calculating unit, a parameter for each of areas respectively classified into categories set by a processing result of the clustering processing, and
the image segmenting unit performs the image segmentation processing according to an arithmetic operation of a contour detecting method employing a dynamic contour model specified according to a number of categories set by the processing result of the clustering processing and parameters set by the parameter setting unit.

4. The medical image processing apparatus according to claim 1, wherein the medical image is an endoscopic image.

5. The medical image processing apparatus according to claim 1, wherein at least one of a blood vessel and a pit structure is included in the categories set by the category setting unit.

6. A medical image processing apparatus capable of performing image segmentation processing for a medical image comprising:
a feature value calculating unit that calculates at least one feature value from the medical image;
a structural component area setting unit that sets plural structural component areas corresponding to structural components included in the medical image;
an area integrating unit that integrates areas having the feature value similar to each other in the respective plural structural component areas;
a category setting unit that sets categories on the basis of a result of the integration by the area integrating unit;
a parameter setting unit that sets, on the basis of the feature value in the respective structural component areas obtained as the result of the integration by the area integrating unit, a parameter for each of the structural component areas obtained as the integration result; and
an image segmenting unit that performs the image segmentation processing for the medical image according to an arithmetic operation of a contour detecting method employing a dynamic contour model specified according to a number of categories set by the category setting unit and parameters set by the parameter setting unit.

7. The medical image processing apparatus according to claim 6, wherein the medical image is an endoscopic image.

8. The medical image processing apparatus according to claim 6, wherein at least one of a blood vessel and a pit structure is included in the categories set by the category setting unit.

9. A medical image processing method for performing image segmentation processing for a medical image comprising:
a feature value calculating step for calculating at least one feature value from the medical image;
a category setting step for setting, on the basis of the feature value calculated by the feature value calculating step, plural categories in the medical image;
a parameter setting step for setting, on the basis of the feature value calculated by the feature value calculating step, a parameter for each of areas of the medical image respectively classified into the categories set by the category setting step; and
an image segmenting step for performing the image segmentation processing for the medical image according to an arithmetic operation of a contour detecting method employing a dynamic contour model specified according to a number of categories set by the category setting step and parameters set by the parameter setting step.

10. The medical image processing method according to claim 9, further comprising a structural component area extracting step for extracting an area corresponding to a structural component included in the medical image, wherein
in the feature value calculating step, at least one feature value is calculated from each of the areas extracted by the structural component area extracting unit, and
in the category setting step, plural categories corresponding to each of the areas extracted by the structural component area extracting step are set on the basis of the feature value calculated by the feature value calculating step.

11. The medical image processing method according to claim 9, wherein
in the category setting step, clustering processing is applied to the plural categories on the basis of a distribution state of the feature value calculated by the feature value calculating step,
in the parameter setting step, on the basis of the feature value calculated by the feature value calculating unit, a parameter is set for each of areas respectively classified into categories set by a processing result of the clustering processing, and
in the image segmenting step, the image segmentation processing is performed according to an arithmetic operation of a contour detecting method employing a dynamic contour model specified according to a number of categories set by the processing result of the clustering processing and parameters set by the parameter setting step.

12. The medical image processing method according to claim 9, wherein the medical image is an endoscopic image.

13. The medical image processing method according to claim 9, wherein at least one of a blood vessel and a pit structure is included in the categories set by the category setting step.

14. A medical image processing method for performing image segmentation processing for a medical image comprising:
a feature value calculating step for calculating at least one feature value from the medical image;
a structural component area setting step for setting plural structural component areas corresponding to structural components included in the medical image;
an area integrating step for integrating areas having the feature value similar to each other in the respective plural structural component areas;
a category setting step for setting categories on the basis of a result of the integration by the area integrating step;
a parameter setting step for setting, on the basis of the feature value in the respective structural component areas obtained as the result of the integration by the area integrating step, a parameter for each of the structural component areas obtained as the integration result; and
an image segmenting step for performing the image segmentation processing for the medical image according to an arithmetic operation of a contour detecting method employing a dynamic contour model specified according to a number of categories set by the category setting step and parameters set by the parameter setting step.

15. The medical image processing method according to claim 14, wherein the medical image is an endoscopic image.

16. The medical image processing method according to claim 14, wherein at least one of a blood vessel and a pit structure is included in the categories set by the category setting step.
